(19) United States
(12) Patent Application Publication
(10) Pub. No.: US 2006/0221038 A1
(43) Pub. Date: Oct. 5, 2006

(54) Method and arrangement for calibrating an arangement for driving image-reproducing means subject to inertia

(75) Inventors: Torsten Solf, Aachen (DE); Martin Weibrecht, Aachen (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/568,555

(22) PCT Filed: Aug. 16, 2004
(86) PCT No.: PCT/IB04/51464

§ 371 Date: Feb. 17, 2006

(30) Foreign Application Priority Data
Aug. 22, 2003 (EP) 03102631.3

(51) Int. Cl. G09G 3/36

(52) U.S. Cl. 345/98

(57) ABSTRACT

In a method and arrangement for correcting an arrangement for driving imagereproducing means subject to inertia, and particularly liquid crystal displays, wherein a stored correcting variable is added to infed video signals to compensate for the effects of inertia, which correcting variable depends on changes in the video signals from frame to frame, and wherein the corrected video signals are conveyed to the image-reproducing means, provision is made for a test pattern that contains signal jumps that occur from frame to frame to be generated, for the signal jumps to vary in respect of their sign, their size and their position in the amplitude range of the video signals, for the test video signals to be shown on the imagereproducing means at least in a part that is covered by at least one opto-electrical sensor, and for correcting parameters to be derived from the signals generated by the at least one optoelectrical sensor while taking account of the totality of the signals generated by the at least one opto-electrical sensor.

The invention relates to a method and arrangement for calibrating an arrangement for driving image-reproducing means subject to inertia, and particularly liquid crystal displays, wherein a stored correcting variable is added to infed video signals to compensate for the effects of inertia, which correcting variable depends on changes in the infed video signals from frame to frame, and wherein the corrected video signals are conveyed to the image-reproducing means.

Liquid crystals displays (LCDs) are well known for having an unsatisfactory time response. When an infed video signal jumps between two successive frames, this does not result in a corresponding jump in the luminance emitted by the LCD. Instead, the liquid crystal display shows a noticeable inertia, which means that the luminance emitted approaches the preset value only gradually. The transition may be drawn out over a plurality of refresh cycles. In image sequences depicting motion, this characteristic results in motion-related errors, which take the form in particular of edges being reproduced with a blur. The motion-related error depends on the amplitude of the video signal that is current at the time and on the previous video signals. Also, the luminance response of the liquid crystal display depends on the specific technology that is used in the particular case.

Because of the blurred edges of moving objects in image sequences, this effect will also be referred to below as motion blur. In a method that has become known from, for example, U.S. Pat. No. 6,304,254 B1, the frame that is previous at the time is stored. The values of the individual pixels in the current frame and the previous frame are entered in a table and from the table is read a correcting variable that causes a jump in the video signal to be overdriven.

In what follows, the correcting variables required for all the signal jumps will also be referred to, as a whole, as a compensating scheme. The compensating scheme depends on various factors including, amongst others, the temperature of the liquid crystal display. The fact of temperature being taken into account when applying the compensating scheme is already known from U.S. Pat. No. 6,304,254 B1, where the value at the time of the ambient or liquid temperature is applied to an extra input of a table. Although this gives temperature-dependent control of the compensating scheme, it does not provide complete calibration.

Calibration is achieved by the method according to the invention by generating a test pattern that contains signal jumps that occur from frame to frame, by varying the signal jumps in respect of their sign, their size and their position in the amplitude range of the video signals, by showing the test video signals on the image-reproducing means at least in a part that is covered by at least one opto-electrical sensor, and by deriving correcting parameters from the signals generated by the at least one opto-electrical sensor while taking account of the totality of the signals generated by the at least one opto-electrical sensor.

The method according to the invention has the advantage that the actual output variable from the liquid crystal display, namely its luminance, is used to calibrate the compensation scheme.

To save storage space, the method according to the invention may be so arranged that of all the possible signal jumps, only selected datum values are used to construct the test pattern.

The method according to the invention may be further developed by causing the calibration to be performed each time the image-reproducing means is switched on. To allow for changes that take place over the course of operation, provision may also be made for the calibration to be repeated at preset intervals of time.

Alternatively, the method according to the invention may also be so arranged that the temperature of the image-reproducing means is measured at at least one point on the means and is stored at the time of a calibration, and that a further calibration is performed if there are changes in the measured temperature that exceed a preset threshold value. One temperature sensor may be provided in this case, or a plurality of temperature sensors may be arranged to allow for the curve followed by temperature in the vertical direction and, if required, in the horizontal direction too. The curve found for temperature can then be used as well to form the compensation scheme.

The method of calibration according to the invention can be applied together with various methods of compensation. A particularly advantageous combination comprises, to allow the correcting variable to be formed, providing a model of the image-reproducing means that contains the correcting parameters, which model has a state variable as its output variable, the video signals as a first input variable and the state variable from a previous frame as a second input variable, and, also to allow the correcting variable to be derived, using a table that has the infed video signals and the state variable from the previous frame as its input variables and the corrected video signals as its output variable. The model may also be incorporated in the table in this case.

The state variable in this case is a numerical representation of a variable derived from the curve followed by luminance over time that is caused by signal jumps. This variable may for example be the luminance at the end of a refresh cycle or the mean of luminance over a refresh cycle.

An application employing a different method of compensation comprises, to allow the correcting variable to be derived, providing a table containing the correcting parameters, which table has the infed video signal and the video signal for the previous frame as its input variables and the correcting variable as its output signal.

To enable the compensation set by the calibration to be monitored during the ongoing operation of the image-reproducing means, provision may also be made in the method according to the invention for, during the showing of video signals of any desired kind on the image-reproducing means, the signals generated by the opto-electrical sensor to be compared with the video signals of any desired kind, and for a calibration to be performed if there are wide deviations in respect of time response.

The invention also covers an arrangement for performing the method according to the invention which comprises arranging the at least one opto-electrical sensor at the edge of the image-reproducing means.

In an advantageous embodiment of this arrangement, provision is made for the at least one opto-electrical sensor to be arranged outside the image area of the image-reproducing means and for an optical means to be provided to guide the light from the image area to the opto-electrical sensor. This largely rules out the possibility of part of the image being hidden by the opto-electrical sensor. The means for guiding the light may be glass fibers or semi-transparent mirrors.

Another embodiment comprises making the at least one opto-electrical sensor pivotable. In this way, the sensor can be totally removed from the field of vision if required.

Finally, provision may be made in the arrangement according to the invention for a plurality of opto-electrical sensors to be arranged at different points at the edge of the image area. Allowance can be made in this way for local differences in the behavior of the liquid crystal display. This is for example the case when the liquid crystal display is exposed to different mechanical stresses.

These and other aspects of the invention are apparent from and will be elucidated with reference to the embodiments described hereinafter.

In the drawings:

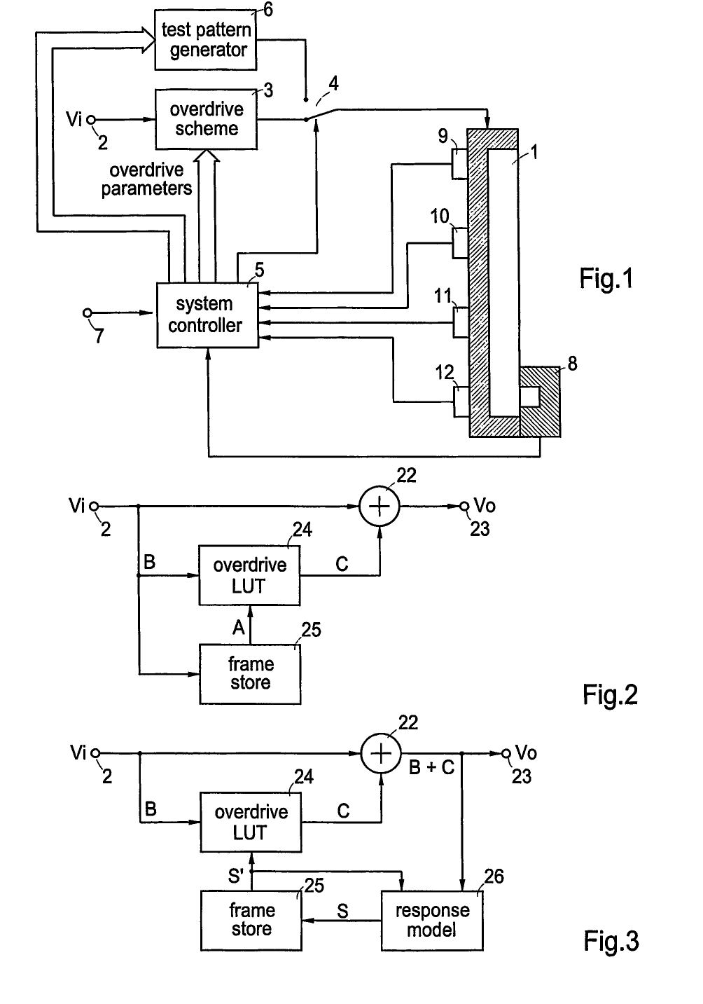

FIG. 1 is a diagrammatic representation of an arrangement for carrying out the method according to the invention,

FIG. 2 shows a known arrangement for compensating for the effects of inertia,

FIG. 3 shows a particularly advantageous arrangement for correcting the effects of inertia, and

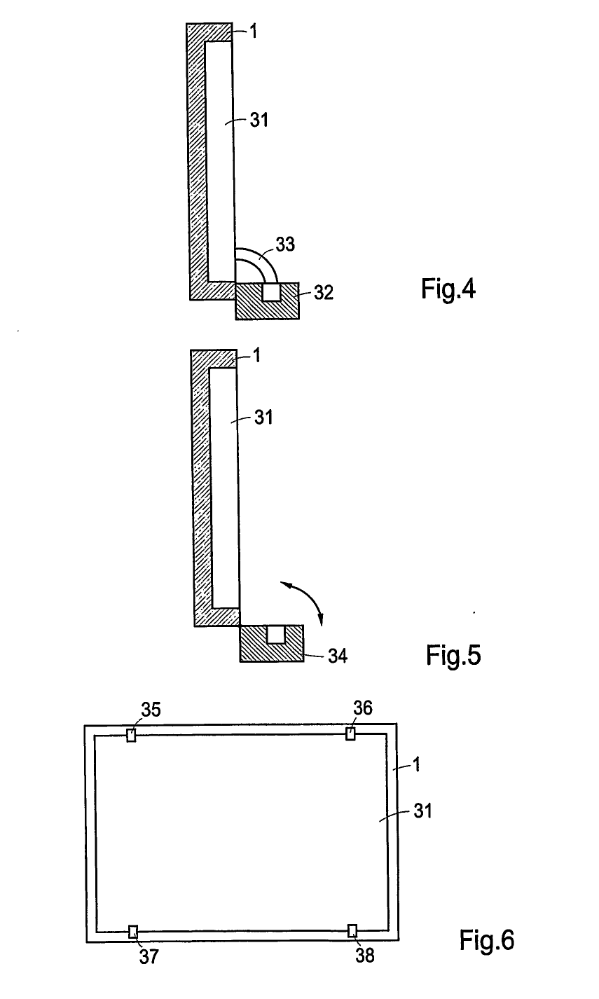

FIGS. 4 to 6 show various arrangements of the opto-electrical sensors.

FIG. 1 shows the liquid crystal display 1 in diagrammatic section. The video signals Vi to be displayed are conveyed to the liquid crystal display 1 via an input 2, a means 3 for compensating for the effects of inertia and a changeover switch 4. The means 3 contains a compensation scheme, also referred to as an overdrive scheme, which will later be elucidated in detail in connection with FIGS. 2 and 3. A system controller 5 controls the running of the method according to the invention and generates data for a test pattern generator 6 and the compensation scheme, which data is fed to the means 3. At an input 7, the system controller receives synchronizing information belonging to the video signals Vi fed in at 2.

In the region of the bottom edge of the liquid crystal display 1 is situated an opto-electrical sensor 8 that converts light generated in this region of the liquid crystal display into electrical signals and feeds the latter to the system controller 5. Situated at the rear of the liquid crystal display 1 are a plurality of temperature sensors 9 to 12 whose outputs are likewise connected to the system controller.

For calibration, the system controller 5 switches the changeover switch 4 to its upper position. It can remain in this position during entire refresh cycles, so that the test pattern is visible over the entire image area, or for only part of the refresh cycles, so that the test pattern only appears in portions that are covered by the opto-electrical sensor.

The test pattern generator 6 is controlled in such a way that it generates signal jumps whose sign, amplitude and position within the amplitude range change and which take place from frame to frame. The curve followed by luminance is measured for each of these signal jumps by means of the sensor 8. This preferably takes place over a plurality of frames because the reaction of the luminance of the liquid crystal display also extends over a plurality of frames. Once the successive responses of the luminance to the signal jumps generated have been measured and stored, the system controller 5 calculates from them a compensation scheme that is recorded in the means 3.

The compensating arrangement shown in FIG. 2 has an input 2 for the infed video signals Vi, which signals make their way via an adder 22 to an output 23 and are fed from there to the liquid crystal display as corrected video signals Vo. The video signals are in the form of digital signals, with a value being assigned to each pixel. These values are stored in a store 25 for one frame at a time and, simultaneously with the values A for the previous frame read out from the frame store 25, are fed as input variables to a look-up table (overdrive LUT). For each pair A, B, the latter contains a value of the correcting variable C, although for reasons of storage space only datum values can be stored and the rest of the values are obtained by interpolation.

The correcting variable C taken from the look-up table 24 is selected to be such that motion blur is compensated for as satisfactorily as possible, and it is conveyed to the adder 22. As can be seen from FIG. 2, in obtaining the correcting variable it is only the previous frame that is allowed for apart from the current frame.

It is true that motion blur can be improved to a first approximation with the arrangement shown in FIG. 2, but the arrangement does have various disadvantages. In this way, overdriving is not possible at the boundaries of the amplitude range of the amplifiers of the liquid crystal display for example. If however there is no overdriving for this reason then, because only one frame is stored, it is also impossible for a subsequent correction to be made after a jump of this kind. These disadvantages are avoided by the arrangement shown in FIG. 3.

In the compensating arrangement shown in FIG. 3, the corrected values B+C of the video signals Vo are fed to a model 26 of the liquid crystal display. The model represents the luminance response of the liquid crystal display to the video signal that is being fed to it at the time and is therefore designated a “response model”. Its output variable S is stored in the frame store 25. The variable S′ for the previous frame, which is read out of the frame store 25, is used as an input variable to the model 26 in addition to B+C. What is thus obtained is a recursive structure, thus enabling a plurality of preceding frames to be taken into account in deriving the correcting variable C. Like the variable A which was described above in connection with FIG. 2, S′ is fed to the look-up table together with the B values.

In the embodiment shown in FIG. 4, an opto-electrical sensor 32 is so arranged that it does not obstruct vision of the image area 31 of the image-reproducing means 1. A thin light guide 33 is provided which passes the light generated in a sub-area of the image area 31 to the opto-electrical sensor 32.

FIG. 5 shows an embodiment having a pivotable opto-electrical sensor 34 which can be pivoted in front of the bottom part of the image area, at the time of a manually initiated correcting operation for example.

In the embodiment shown in FIG. 6, there are four opto-electrical sensors 35, 36, 37, 38 provided which receive light from the edge of the image area 31 at the top and bottom. In this way, allowance can be made in the correction for behavior by the liquid crystal display that differs at different edges.

1. A method of calibrating an arrangement for driving image-reproducing means subject to inertia, and particularly liquid crystal displays, wherein a stored correcting variable is added to infed video signals to compensate for the effects of inertia, which correcting variable depends on changes in the video signals from frame to frame, and wherein the corrected video signals are conveyed to the image-reproducing means, characterized in that
a test pattern is generated that contains signal jumps that occur from frame to frame,
the signal jumps vary in respect of their sign, their size and their position in the amplitude range of the video signals,
the test video signals are shown on the image-reproducing means at least in a part that is covered by at least one opto-electrical sensor, and
correcting parameters are derived from the signals generated by the at least one opto-electrical sensor while taking account of the totality of the signals generated by the at least one opto-electrical sensor.

2. A method as claimed in claim 1, characterized in that, of all the possible signal jumps, only selected ones are used as datum values for forming the test pattern.

3. A method as claimed in claim 1, characterized in that the calibration takes place each time the image-reproducing means is switched on.

4. A method as claimed in claim 1, characterized in that the calibration is repeated at preset intervals of time.

5. A method as claimed in claim 3, characterized in that the temperature of the image-reproducing means is measured at at least one point thereon and is stored at the time of a calibration, and in that a further calibration is performed if there are changes in the measured temperature that exceed a preset threshold value.

6. A method as claimed in claim 1, characterized in that,
to allow the correcting variable to be formed, there is provided a model of the image-reproducing means that contains the correcting parameters, which model has a state variable as an output variable, the video signals as a first input variable and the state variable from a previous frame as a second input variable and,
also to allow the correcting variable to be derived, a table is used that has the infed video signals and the state variable from the previous frame as input variables and the corrected video signals as an output variable.

7. A method as claimed in claim 1, characterized in that, to allow the correcting variable to be formed, there is provided a table that contains the correcting parameters, which table has the infed video signal and the video signal for the previous frame as input variables and the correcting variable as an output signal.

8. A method as claimed in claim 1, characterized in that, during the showing of video signals of any desired kind on the image-reproducing means, the signals generated by the opto-electrical sensor are compared with the video signals of any desired kind, and in that a calibration is performed if there are wide deviations in respect of time response.

9. An arrangement for calibrating an arrangement for driving image-reproducing means subject to inertia, and particularly liquid crystal displays, wherein a stored correcting variable is added to infed video signals to compensate for the effects of inertia, which correcting variable depends on changes in the video signals from frame to frame, wherein the corrected video signals are conveyed to the image-reproducing means, and wherein at least one opto-electrical sensor detects at least a part of a test pattern that is shown on at least a part of the image area of the image-reproducing means, characterized in that the at least one opto-electrical sensor is arranged at the edge of the image-reproducing means.

10. An arrangement as claimed in claim 9, characterized in that the at least one opto-electrical sensor is arranged outside the image area of the image-reproducing means and an optical means is provided to guide the light from the image area to the opto-electrical sensor.

11. An arrangement as claimed in claim 9, characterized in that the at least one opto-electrical sensor is pivotable.

12. An arrangement as claimed in claim 9, characterized in that a plurality of opto-electrical sensors are arranged at different points at the edge of the image area.
